(19) United States
(12) Patent Application Publication
(10) Pub. No.: US 2025/0231328 A1
(43) Pub. Date: Jul. 17, 2025

(54) LIGHTWEIGHT OPTICS

(71) Applicant: Gooch & Housego PLC, Ilminster (GB)

(72) Inventor: Peter MACKAY, Ilminster (GB)

(21) Appl. No.: 19/021,854

(22) Filed: Jan. 15, 2025

(30) Foreign Application Priority Data
Jan. 15, 2024 (GB) 2400577.9

(51) Int. Cl. G02B 5/08

(52) U.S. Cl. CPC G02B 5/08

(57) ABSTRACT

The present disclosure provides a mirror device comprising a reflector plate having a rear face and a reflective front face, and a core attached to the rear surface of the reflector plate. The core comprises a first plate and a second plate, the first plate being stacked on the second plate, wherein the first plate and second plate are each monolithic and comprise a glass or ceramic. The mirror device further comprises a plurality of first holes formed in the first plate, each first hole formed through the entire thickness of the first plate, and a plurality of second holes formed in the second plate, each second hole formed through the entire thickness of the second plate, where a mean width of the first holes is less than a mean width of the second holes.

### CROSS-REFERENCE TO RELATED APPLICATION

This present application claims priority to United Kingdom Patent Application No. 2400577.9, filed Jan. 15, 2024, the disclosure of which is hereby incorporated by reference in its entirety.

### TECHNICAL FIELD

This disclosure relates to mirror devices and methods of manufacturing mirror devices.

### BACKGROUND

Optical mirrors may be used to steer a laser beam by changing an angle of the mirror relative to the impingent beam. The mirror's size may be based on both the laser fluence resistance of the surface of the mirror, and the required optical performance of the complete system. Some beam steering applications necessitate a large mirror diameter, which can increase the weight of the mirror in proportion to the radius cubed. In an example, a mirror of diameter 500 mm will be around 100 mm thick and, using common materials for such mirrors, have a mass of around 50 kg. The thickness of the mirror is usually chosen in order to ensure the stability of the optical form of the surface so that the beam can be steered accurately. Greater thicknesses lead to greater stability, but at the cost of increased weight.

Lighter mirrors are easier to store and transport, and require less power to actuate when the mirror is moved during operation. For example, lightweight mirrors may be used in satellites when using optical techniques to measure parameters for climate monitoring and surveillance. The cost of launch of these satellites is directly proportional to the mass of the satellites, and therefore reducing the overall mass of the system is beneficial. In a laser system, moving a steering mirror that must rapidly change position or orientation, accelerations and decelerations of the mirror may be limited by inertial forces. This impacts the response time for steering the beam, for example so as to acquire a target for the laser, as well as the ability of the system to adequately track a target. Reducing the overall mass of the mirror can therefore also improve the dynamic performance of the optical system to which it belongs.

Existing techniques for creating a lightweight core may compromise the optical performance and/or the stability of the mirror. For example, it is known to create a “honeycomb” core, or a core with channels running through it. However, this type of core is expensive and time consuming to fabricate. The core may be created by depositing the core material and bonding it to a reflector plate, which involves expensive machinery that is difficult to scale. It is also known to use a lattice or mesh structure for the core. However, this type of core may also be difficult and/or expensive to fabricate.

The present disclosure seeks to address these and other disadvantages encountered in the prior art by providing an improved mirror device.

### SUMMARY

An aspect of an invention is defined in the appended claims.

### BRIEF DESCRIPTION OF THE DRAWINGS

Specific embodiments are now described, by way of example only, with reference to the drawings, in which:

FIGS. 1a and 1b each depict an exemplary lightweight optical mounting system.

FIG. 2 depicts a mirror device according to embodiments of the present disclosure.

FIG. 3 depicts a mirror device according to embodiments of the present disclosure.

FIGS. 4a and 4b depict a lightweight core according to embodiments of the present disclosure.

FIGS. 5a, 5b, 5c and 5d each depict a plan view of a layer of a lightweight core according to embodiments of the present disclosure.

FIGS. 5e, 5f and 5g each depict a plan view of a sectioned layer of a lightweight core according to embodiments of the present disclosure.

FIGS. 6a and 6b depict a lightweight core according to embodiments of the present disclosure.

FIGS. 7a and 7b depict a lightweight core according to embodiments of the present disclosure.

FIGS. 8a and 8b depict a lightweight core according to embodiments of the present disclosure.

FIG. 9 depicts a method for manufacturing a mirror device according to embodiments.

### DETAILED DESCRIPTION

In overview, and without limitation, the application discloses a mirror device comprising a core attached to a rear surface of a reflector plate. The core may comprise a plurality of layers. In some implementations, each layer may comprise a plate such that the core comprises a first plate and a second plate stacked on the first plate. A plurality of holes are formed in each plate, through the entire thickness. A mean width of the first holes in the first plate is less than a mean width of the second holes in the second plate. This core arrangement helps to reduce the total mass of the mirror device by removing that material that makes less of a contribution to the stability of the front surface. In other words, by reducing the weight without compromising the stability of the reflector plate.

Preferably, the first plate is disposed between the reflector plate and the second plate, such that the mean width of the holes is smaller in the plate that is closest to the reflector plate. This is advantageous as it provides greater stability to the reflector plate, and has less impact on the surface form of the reflector plate. For example, if the holes in the plate adjacent the reflector plate are too large, this can compromise the surface form of the reflector plate by producing undulations in the reflective surface at locations corresponding to the position of the holes.

Preferably, the second holes may be fewer in number than the first holes. Layers closer to the reflector plate, such as the first plate, may have smaller features. In other words, the mean width of the holes in the plates nearer the reflector plate is less than that in the plates further from the reflector plate. In addition, the number holes in plates nearer the reflector plate is greater than that in the plates further from the reflector plate. Arranging the plates in such a way facilitates weight reduction of the mirror device without introducing unwanted deformations in the reflective surface of the reflector plate. Plates further away from the reflector plate may be thicker, which may increase the stiffness over larger length scales.

By using small holes having surrounding portions each supporting a small area of the layer above means that the layer above need not be too thick. Then the next layer down has larger holes providing a larger unsupported distance in the plate above and hence all the plates above together will have adequate thickness to cross the holes with minimal deformation. This pattern continues until the total thickness allows the entire diameter of the mirror to have sufficient support to be stable. It is a consequence of this scaling that the layers closer to the front reflector plate have smaller holes and are thinner and hence are denser. Further from the front reflector plate, since the holes can be larger and the thickness greater this can allow a lower average density. The average density is equal to the mass of the plate divided by the total volume of the plate. The total volume of the plate is the sum of the volume of the material from which the plate is composed and the total volume of the holes contained therein. Plates nearer the reflector plate may therefore have a higher average density. Plates further away from the reflector plate may have a lower average density.

Preferably, the core may comprise a third plate in a third layer. As per the difference in thickness, and the number and mean width of the holes between the first and second plate, the same differences are true between the second and third plate. That is, the third plate may be thicker than, and have larger and fewer holes than the second plate. Embodiments include between two and five different plates following this same pattern of relative thickness, number and size of holes to optimise weight reduction and stability.

While the present disclosure focuses primarily on mirror devices having cores with two to five layers, the skilled person will appreciate that the methods and principles described herein can also apply to mirror devices having cores with a higher number of layers.

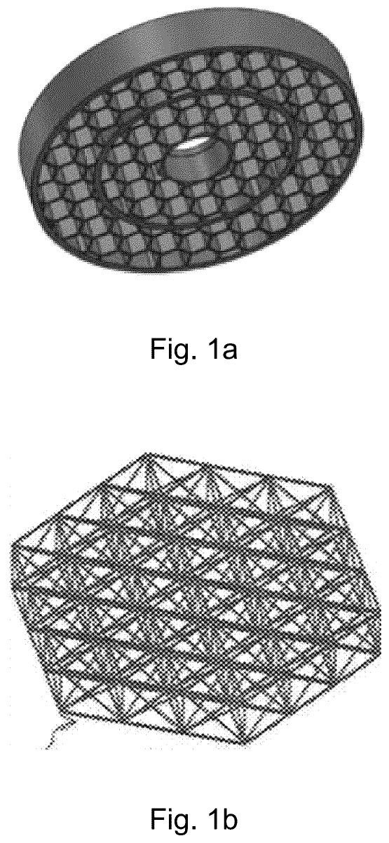

FIGS. 1a and 1b depict examples of known lightweight cores suitable for mirror devices. FIG. 1a depicts a core with cells or channels that extend uniformly from the front surface to the rear surface of the core. FIG. 1b depicts a core comprising structural members or ribs that join to form a 3D mesh.

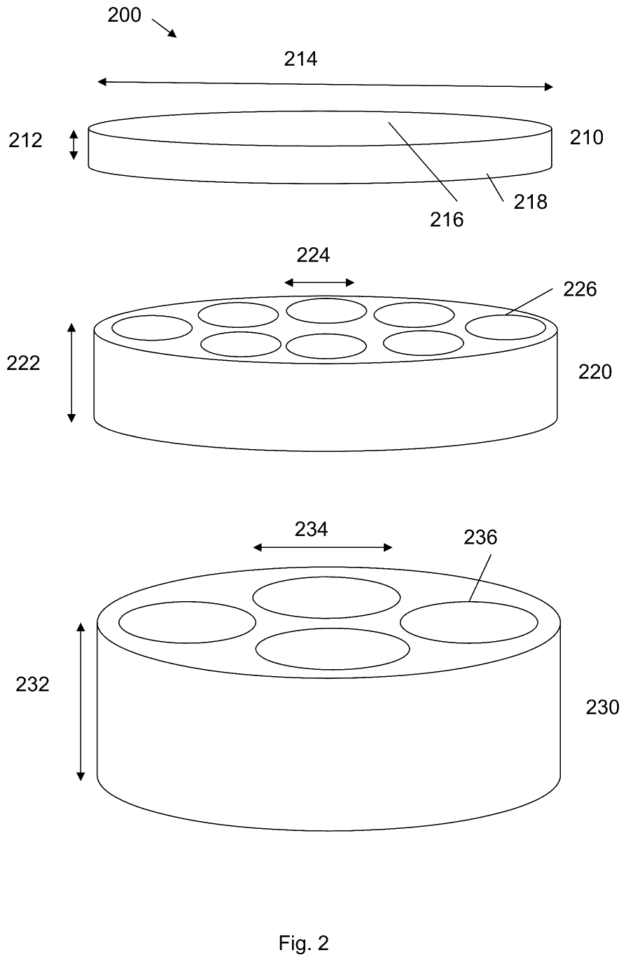

FIG. 2 depicts an exploded view of a mirror device 200 according to embodiments. The device is suitable for use as a lightweight mirror in, for example, a satellite or laser beam steering device.

The mirror device 200 comprises a reflector plate 210, which has a diameter 214, a thickness 212, a front face 216 and a rear face 218. The reflector plate may also be referred to as a mirror plate or as a plate having a mirrored surface. The front face 216 of the reflector plate is the optically active (i.e. reflective) surface, and the rear face 218 is the surface to which the core is attached. The front face may be polishable such that it can be made optically active. In some implementations, the reflector plate may comprise optical coatings such as band selective or polarising coatings. The reflector plate may be planar, or alternatively may be concave or convex depending on the intended application.

The reflector plate 210 may be cylindrical, such that the reflective front face 216 has a circular shape in plan view (i.e. viewed normal to the reflective surface). In other implementations, the reflective front face may be a different shape, such as an elliptical or a shape which is particularly suitable for an elliptical beam shape formed when a circular beam reflects off a mirror (for example, at a 45 degree angle of incidence). In some implementations, an irregular octagonal surface may be used to approximate an elliptical beam shape. Advantageously, an octagonally-shaped plate is simple to manufacture from a square or rectangular plate and has flat edges which may be preferable for some mounting schemes.

The reflector plate may comprise a glass or ceramic including one or more of an ultra-low expansion glass material, a fused silica material, a carbon composite material, an silica carbide material, and/or a beryllium material.

The mirror device 200 further comprises a first plate 220 and a second plate 230, the first plate 220 being stacked on the second plate 230. That is, a major face of the first plate 220 mates with a major face of the second plate 230 such that the first plate 220 is on top of the second plate 230.

The plates are monolithic and comprise a glass or ceramic. For example, the plates may comprise one or more of a silicon carbide material, a ceramic material, fused silica, a ceramic-doped polymeric material, a glass-ceramic material, an ultra-low expansion glass material, a carbon-nanotube-filled polymeric material, and/or a carbon composite material. These core materials may be selected in order to minimise the coefficient of thermal expansion (CTE), as well as minimizing the weight of the core and its modulus of elasticity.

In some implementations, the first plate is disposed between the reflector plate and the second plate, as depicted in FIG. 2. The first plate may be immediately adjacent to the reflector plate and may be bonded to it, and the first plate may also be immediately adjacent to the second plate and bonded to it.

The plates may be bonded by applying a low-expansion technique with a thin bond line to adjacent plates. The thin bond line may have a thickness of less than 50 micrometres. The technique may comprise one of: hydroxide catalysis bonding, cold metal bonding, diffusion bonding, glass frit, optical contacting and/or low CTE epoxy bonding. This may form a bonding layer disposed between the first plate and second plate and/or between the first plate and the reflector plate. The bonding layer may comprise an epoxy, glass frit, sodium silicate or metal.

A plurality of first holes 226 is formed in the first plate 220. Similarly, a plurality of second holes 236 is formed in the second plate 230. Each hole is an aperture or channel that extends from a front surface of a respective plate to the rear surface of the plate. The aperture or channel may have a uniform cross-sectional shape and size. In other words, the shape and size of the hole may not vary from the front surface to the second surface of the plate. This has the effect of simplifying manufacture of the plate since techniques such as waterjet cutting can be used to produce the holes instead of CNC machining, thus reducing cost and time in the manufacturing process.

The mean width of the first holes 226 is less than a mean width of the second holes 236. This can be true of the mean width of each individual hole or an average (mean) of the mean width of all first holes 226 compared with that of all second holes 236. Alternatively, or in addition, the number of second holes is less than the number of first holes. More uniform structural support for the reflector plate is provided by a first plate structure with a larger number of smaller holes, while this structure is itself supported by another structure with a lower number of larger holes, and therefore a lower mass per unit volume than the first plate. That is, the first plate may have a first mass per unit volume (calculated taking into account the volume of the overall plate including the volume of the holes) and the second plate may have a second mass per unit volume (calculated in the same way), wherein the second mass per unit volume is less than the first mass per unit volume.

Optionally, the number of first holes may be an integer multiple of the second number of holes. The integer may be between 2 and 9, optionally between 3 and 5, and most preferably 4. This can allow an integer number of first holes to be aligned within the same region defined by one of the second holes, thus providing a more uniform support structure under the first plate.

The holes 226, 236 are depicted in FIG. 2 as uniformly-shaped and uniformly-sized, circular holes in a regularly-spaced pattern, however the holes may take any shape and/or be non-uniform in size or shape. They may be arranged with in a regular pattern with a fixed distance between each hole, or in a random pattern. In some implementations, the first and second holes are formed of a base shape, and the base shape may be one of: substantially triangular, substantially circular, substantially square, or substantially hexagonal. The base shape of the first holes may be the same as the base shape of the second holes. In other implementations, the holes may be random shapes or there may be no relationship between the shapes of the holes.

Optionally, the reflector plate may comprise features machined into the rear surface thereof. These features may be of a scale smaller than the adjacent core layer. For example, indentations in the rear surface of the reflector plate may have a smaller mean width than the first plurality of holes 226 in the first plate 220.

It is advantageous to reduce the weight of each plate while retaining structural stability. Interlocking or tessellating shapes such as triangles, hexagons and squares may reduce the mass remaining in the plate since the width of the walls separating the holes can be made uniform. The inventors have recognised that such shapes are especially suitable for forming the core of a lightweight mirror. It may be particularly advantageous for there to be overlap between the walls of each adjacent layer (e.g. overlap between the walls of the second plate and a subsection of the walls of the first plate), as it improves the stability of the core. The overlap may be such that the full length of all walls of the second plate are overlapped by walls of the first plate.

Each of the first holes 226 is formed through the entire thickness 222 of the first plate. Similarly, each of the second holes 236 is formed through the entire thickness 232 of the second plate. The holes may be formed through the entire thickness of the plate, for example using water jet cutting or CNC machining.

The first plate 220 and the second plate 230 form a core. The core is attached to the rear surface of the reflector plate, such that the reflective front face of the reflector plate is facing outwards. Each plate may form a layer of the core. Optionally, the core comprises more than two plates. For example, there may be a third plate arranged such that the second plate is disposed between the first and third plates. A plurality of third holes may be formed in the third plate, each third hole formed through the entire thickness of the third plate. The relative relationship between the number, dimensions and arrangement of the third holes and second holes may be the same as the relative relationship between the second holes and first holes as described above. For example, the number of third holes may be less than the number of second holes, and the third holes may have a mean width greater than the mean width of the second holes.

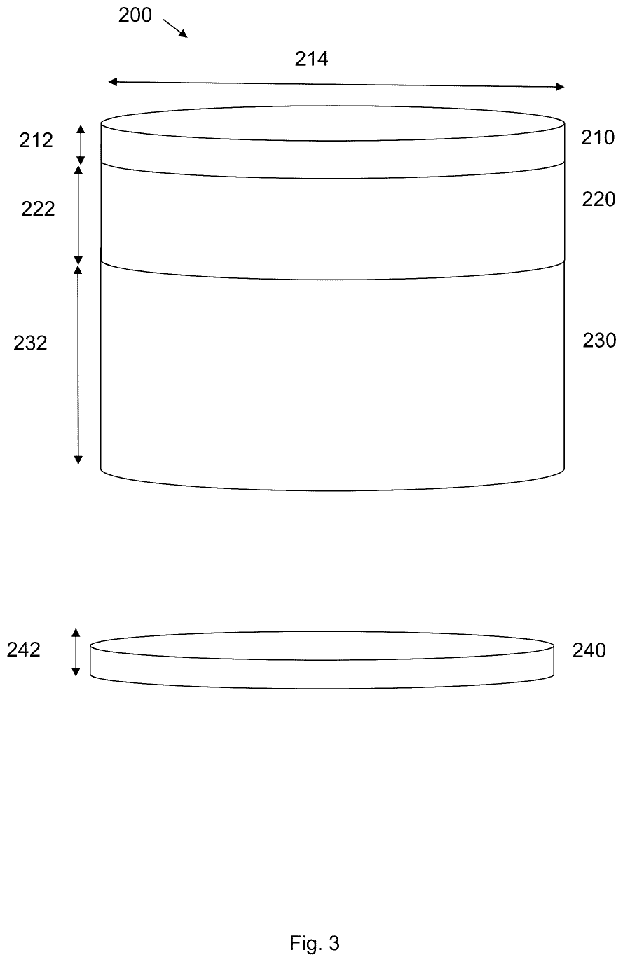

Optionally, the device further comprises a back plate. FIG. 3 depicts an exploded view of another mirror device 300 according to the present disclosure. The reflector plate 210, the first plate 220 and the second plate 230 are depicted, as well as a back plate 240. The reflector plate 210, the first plate 220 and the second plate 230 are as described above in relation to FIG. 2 and therefore a detailed description thereof will be omitted. The back plate may also be referred to as a back layer. The diameter of the back plate may be the same as the diameter of the reflective plate 210 and the first and second plates 220, 230 of the core. The back plate has a thickness 242.

The back plate may be optically active. For example, it can also include a polished mirror surface suitable for use in optical instruments, though embodiments are not limited thereto and the backplate may not serve any optical purpose. The back plate may be monolithic. Advantageously, the back layer may comprise a lightweight material that is the same as the material of the core, such as a glass or ceramic.

In some implementations, the back plate has mounting features that enable the mirror device to be mounted onto another component, apparatus or structure and aligned for use. Mounting features may comprise one or more of: a protrusion from the surface of the back plate such as a pin that can interact with a hole of another component, a flat area on the surface suitable for gluing to another component, a hole configured to interact with a pin of another component. Alternatively, or in addition, plates (layers) in the core may also include mounting features, for example on an external surface thereof so that the mirror device can be mounted with or without mounting features on the back plate. The back plate may additionally or alternatively have features that facilitate bonding it to the core.

There may be holes or apertures in the back plate. Advantageously, this may facilitate airflow through the mirror device or may ventilate cavities in the mirror device such as in the core. In some implementations, the mirror device should be suitable for use in a vacuum, and therefore may allow trapped air to escape from the core. Pressure changes within a sealed cavity may cause distortions if the internal air is trapped at a certain pressure. Holes or apertures in the backplate are particularly advantageous if the mirror device is to be used in a vacuum or for withstanding pressure changes due to the airflow. Controlled air may be blown onto the rear of the mirror device to assist with thermal stabilisation. At least a portion of the backplate may provide a cross-bracing of at least one hole in the adjacent plate (e.g. the second or the third plate) in the core. That is, the portion of the backplate may brace or span the at least one hole in an adjacent plate, which may make the core more rigid or robust. Additionally or alternatively, a different form of pattern may be used on the back plate to cross brace the adjacent layer and provide support. For example, a cross-bracing portion may take the form of one or more structural members that span a portion of the diameter of the back plate. In another example, structural members may form different patterns to provide support. The cross-bracing portion may span at least one hole in an adjacent plate. In other words, the backplate may have a plurality of recesses machined into either face thereof. The recesses may be formed in the same or a similar pattern to the holes in the plate. Each recess may be a blind hole machined or formed through only a portion of the thickness of the backplate. Walls of the backplate material may be formed between the recesses. In this case, each wall can act as the cross-bracing portion of the backplate, by extending from one side to another (e.g. opposite) side of a corresponding hole in an adjacent plate in the core.

The thickness of the reflector plate, the layers or plates of the core and the back plate may be different from one another. For example, the thickness of the first plate 220 and second plate 230 of the core may not be equal, and preferably, the thickness of the first plate 220 may be less than the thickness of the second plate 230. Therefore, in some embodiments, the thickness of each plate of the core successively further from the reflector plate increases while the mean width of the holes or apertures increases. In this way, there may be a positive correlation between the plate thickness and mean width of holes. Likewise, there may be a negative correlation between plate thickness and the number of holes since plates further from the reflector plate may have a larger thickness and a lower number of holes than core plates nearer the reflector plate.

In some embodiments, the size of the holes in one plate may be related to the thickness of one or more of the other plate of the core. For example, there can be a first ratio of the size of the first holes (for example the mean width of the first holes) to the thickness of the reflector plate. There can also be a second ratio of the size of the second holes (for example the mean width of the second holes) to the combined thickness of the first plate and reflector plate. Likewise, there can be a third ratio of the size of the third holes to the combined thickness of the reflector plate, first plate and second plate. The first, second and third ratios may be equal to each other. To provide a stable structure with minimal reflector plate distortion while optimally reducing the weight of the mirror device, the first, second and third ratios for a mirror device including a reflector plate having a planar mirror face may be between 3:1 and 7:1, preferably between 4:1 and 6:1, more preferably 5:1. Advantageously, this ratio allows the reflector plate to achieve a tenth wave surface form error. Surface form error is the difference between the desired shape of an optical surface and the actual shape of the optical surface. Typically, it may be calculated by applying a low pass filter to the surface so that surface roughness is excluded. A tenth wave surface form error means that the difference between target or desired surface and the actual surface is less the one tenth the wavelength of light being reflected by the mirror. Other ratios may be appropriate depending on the optical requirements of the assembled mirror and the specific mechanical properties of the material used to make the mirror. A concave or convex mirror may have a different optimum ratio to a planar mirror. Using the range of ratios described above, the size of the first holes may be small enough to support a front reflector plate.

In other words, the thickness 212 of the reflector plate 210 may depend on the size (i.e. mean width) of the first holes 226 when the first plate 220 is immediately adjacent to the reflector plate. For example, if the first ratio is 5:1 and the mean width 224 of the first holes 226 in the first plate 220 is 10 mm, then the reflector plate will have a thickness 212 of 2 mm. Similarly, if the second ratio is 5:1 and the mean width 234 of the second holes 236 is 20 mm, then the combined thickness 212, 222 of the reflector plate and first plate will be 4 mm. In other words, the first plate 220 will also have a thickness 222 of 2 mm. If the third ratio is 5:1 and mean width of third holes in a third plate (not depicted in FIG. 2) is 50 mm, then the combined thickness 212, 222, 232 of the reflector plate, first plate and second plate will be 10 mm and the second plate will have a thickness 232 of 6 mm. This relationship between the feature size (i.e. the mean width of the holes) in one plate and the thickness of the layers above that one plate (i.e. in a direction towards the reflector plate) can be continued for as many layers or stacked plates as required.

Put another way, when the first plate is adjacent to the reflector plate, the first ratio is a ratio of the mean, minimum or maximum width of the first holes in the first plate to a thickness of the reflector plate. The second ratio is a mean, minimum or maximum width of the second holes to a combined thickness of the reflector plate and the first plate.

In embodiments, the ratio of the total thickness of the mirror device to a maximum lateral size (i.e. diameter, span or width) of the mirror device is between 1:3 and 1:7, preferably between 1:4 and 1:6, and most preferably 1:5. For example, with reference to FIG. 2, the combined thickness 212, 222, 232 of the reflector plate 210, first plate 220 and second plate 230 is five times the diameter of the reflector plate. For non-circular reflector plate shapes the equivalent dimension to the diameter is used (e.g., a largest width).

The thickness 242 of back plate 240 may not follow the same thickness ratio as the other components of the mirror device. The thickness 242 of the back plate may be subtracted from its adjacent plate (e.g. the second or third plate) such that the back plate is treated as part of the final, outwards facing layer that is furthest from the reflector plate. In other words, the thickness of the nth plate plus the thickness of the back plate is used in place of the thickness for the nth plate calculated according to the thickness ratios defined herein, wherein n is the total number of plates in the core except for the reflector plate and back plate and the nth plate is a layer of the core akin to the second or third plate having holes as described herein and the nth plate is positioned adjacent the back plate.

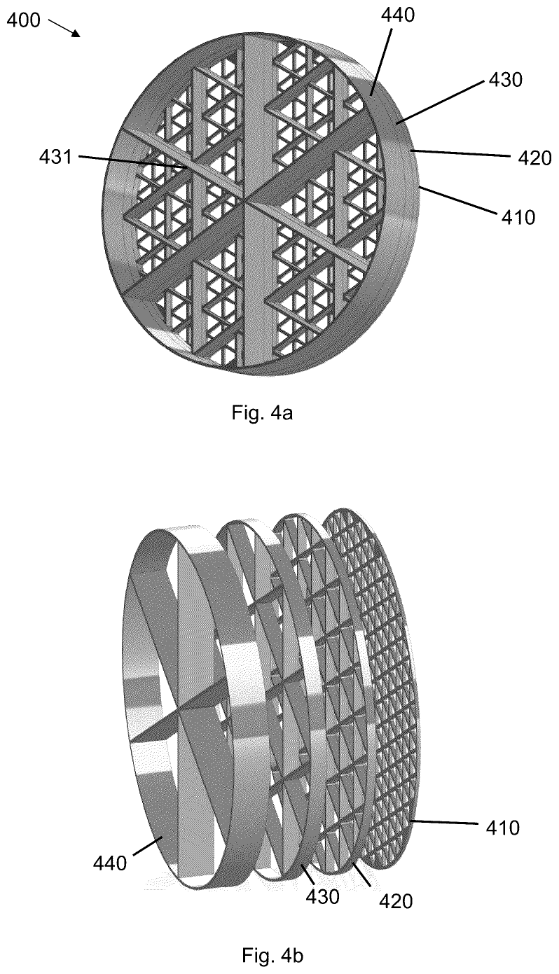

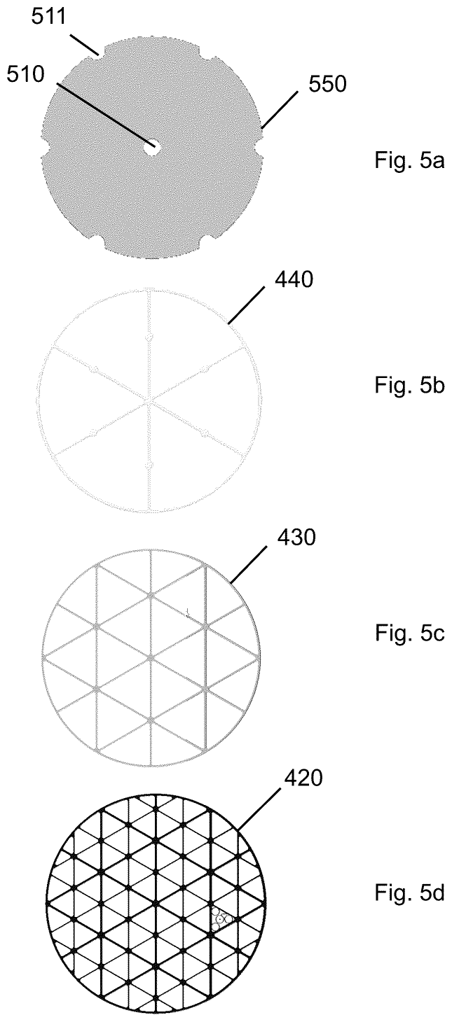

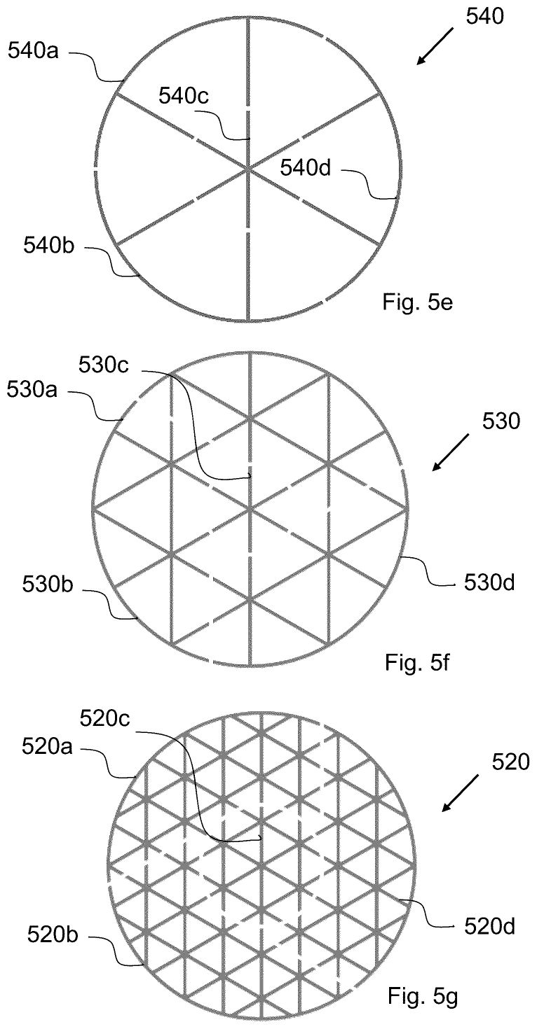

FIG. 4a depicts a core 400 according to embodiments of the present disclosure. In this example, the holes through the entire thickness of each plate in the core are substantially triangular prism in shape. Depending on the cross-sectional shape of the reflector plate (i.e. the outline in plan view), some of the triangular prism shapes may have a curved face which corresponds to the outline shape. FIG. 4b depicts an exploded or expanded view of the core 400 depicted in FIG. 4a. FIG. 5a depicts a backplate in plan view. FIGS. 5b to 5d each depict a plan view of a different layer of the core 400 in FIGS. 4a and 4b.

In FIG. 4a, the core is shown in isometric view revealing the overlapping structures of the individual plates of the core. The exploded view of FIG. 4b shows the individual plates of the core separated from one another. FIGS. 4a and 4b depict a first plate 410 in a first layer. The first layer 410 may be adjacent a reflector plate (not shown in FIGS. 4a and 4b). In some implementations, the reflector plate has mounting or bonding features to facilitate easier bonding between the reflector plate and the front plate.

FIGS. 4a and 4b also show a second plate 420 in a second layer. The second plate is immediately adjacent to the first plate 410, and may be bonded to it. The second plate 420 is also depicted in isolation and in plan view in FIG. 5d.

FIGS. 4a and 4b also show a third plate 430 in a third layer. The third plate may be immediately adjacent to the second plate 420, and may be bonded to it. The third plate 430 is also depicted in isolation and in plan view in FIG. 5c.

FIGS. 4a and 4b also show a fourth plate 440 in a fourth layer. The fourth plate may be immediately adjacent to the third plate 430, and may be bonded to it. The fourth plate 440 is also depicted in isolation and in plan view in FIG. 5c.

Each of the first plate, second plate, third plate and fourth plate depicted in FIGS. 4a and 4b may comprise an outer frame and a plurality of structural members defining edges of the entrances of the holes. The structural members form walls of the holes or apertures. The walls may be uniform throughout the thickness of the plate, as depicted in FIG. 4. In a preferred implementation, the holes are machined through the plate and therefore the holes have the same cross-sectional area throughout the thickness of the plate.

FIG. 5a depicts an optional back plate 550 that includes a hole 510, and notches 511 in the edge of the backplate. In some implementations, these holes or notches may be mounting features that enable the mirror device to be mounted onto another component, apparatus or structure and aligned for use. For example, they may be configured to collocate with a pin or another feature of a separate component such that they slot together. The holes or notches may also facilitate airflow through the mirror device or may ventilate cavities in the mirror device such as in the core. Holes or apertures in the backplate are particularly advantageous if the mirror device is to be used in a vacuum or for withstanding pressure changes due to the airflow.

In some implementations, the back plate of FIG. 5a may be omitted, and holes or notches may optionally be formed in the last layer of the core, such as plate 430 of FIGS. 4a, 4b and 5b.

At least one first wall in the first plate 410 overlaps with at least one second wall in the second plate. This creates a common point between the first plate and the second plate at which the plates can be joined. For example, a wall of the first plate 410 of core 400. The second plate also has a wall in this position such that a second wall of the second plate overlaps one, two or even more first walls of the first plate. The overlap may be partial, such as if the second wall of the second plate is not parallel to the corresponding first walls of the first plate. In this case, the second wall of the second plate may cross the one or more first walls and one or more first holes of the first plate. The areas of overlap of the second walls with the first walls forms potential bonding locations at which the first plate may be bonded to the second plate. Additionally, if a second wall of the second plate crosses one or more of the first holes, a cross-bracing of these first holes may occur and the support provided to the reflector plate and/or the rigidity of the core may be improved.

Optionally, second wall may entirely overlap one or more of the first walls such that there is a continuous locus of common points (or points of overlap) between the first plate and second plate. This is shown in FIG. 4, in which the second walls are shown entirely overlapping corresponding first walls (hidden from view behind the second walls). This may provide improved bonding between the first and second plates, thereby improving the strength of the core.

The same pattern of both partial or complete overlap can occur in relation to the third walls of the third plate and second walls of the second plate. For example, in FIG. 4, the third layer comprising a third plate also has third walls in positions overlapping the second walls such that the third walls are shown completely overlapping corresponding second walls and first walls (both hidden from view behind the third walls). In a partial overlap configuration, the third walls may cross one or more of the second walls or second holes, which may create a similar cross-bracing effect as described above in relation to the second walls and first holes.

The first outer frame of the first plate may overlap with the second outer frame of the second plate. Likewise, the third outer frame of the third plate may overlap with the second outer frame. This may be partial or complete overlap. In FIG. 4, the cross-sectional shape and area of the core is the same in each layer and the outer frames entirely overlap. In other implementations, the shape and/or area may vary throughout the core, or differ from the reflector plate or the back plate and there may only be partial or no overlap between the outer frames. As can be seen in FIGS. 4, 5b, 5c and 5d, there is a circular outer frame for each layer. In some implementations, the outer layers form a continuous wall or edge of the holes between the first plate and second plate. The overlapping regions of each outer frame form common points which may act as bonding sites between adjacent plates.

In some implementations, the outer frame and/or the walls of a plate may comprise enlarged areas, which may increase the area for bonding. FIG. 4 depicts an example of an enlarged area 431 at which the third wall bulges or becomes wider. The enlarged area may coincide with the location at which two or more of the second walls meet (or intersect). The second plate may also have enlarged areas at locations corresponding to the enlarged areas of the third plate, thereby further increasing the bonding area. For some bonding methods, additional material or area of contact may be advantageous as it provides a more secure and reliable bond between adjacent plates.

Each layer of the mirror device may comprise a single plate. In other implementations, a layer may comprise two or more plates that are bonded and are not stacked but rather arranged in the same layer, for example like segments of a pie. In other words, the layers in the design may not be a single piece, but comprised of multiple smaller pieces. Each piece is the same thickness and when placed down together in the same layer. For example, in a two-piece arrangement, a fourth monolithic plate comprising glass or ceramic may be arranged in the same layer of the core as the first plate. The fourth plate has a plurality of fourth holes formed through the entire thickness of the fourth plate. The mean width of the fourth holes may be the same as the first holes. Optionally, the first plate and fourth plate may be identical or reflections of one another. For example, the first and fourth plates may be semi-circular with the same number and pattern of holes such that bonding them together forms a larger circular plate in the first layer. In other words, the first layer may include a plate split into segment-like sections, each having similar or identically sized holes. In this way, larger mirror devices can be manufactured and/or the cost and/or manufacturing complexity can be reduced. Other examples of a single layer including multiple plate sections in are illustrated in FIGS. 5e, 5f and 5g.

FIGS. 5e, 5f and 5g each depict a plan view of a sectioned layer of a lightweight core according to embodiments of the present disclosure. The layers in FIGS. 5e, 5f and 5g are the same as the plates described with reference to FIGS. 5b, 5c and 5d, respectively, except where described otherwise as follows. A detailed description of identical features is omitted. Each of FIGS. 5e, 5f, and 5g depicts a layer having four-piece (or four-section) arrangement including a first plate section 540a, 530a, 520a; second plate section 540b, 530b, 520b; third plate section 540c, 530c, 520c; and fourth plate section 540d, 530d, 520d. The third plate section 540c, 530c, 520c makes up the central area of the layer. The central area extends across an approximately circular region. The first plate section 540a, 530a, 520a; second plate section 540b, 530b, 520b; and fourth plate section 540d, 530d, 520d surround the third plate section 540c, 530c, 520c and form the outer circumference of the layer. The first plate section 540a, 530a, 520a; second plate section 540b, 530b, 520b; and fourth plate section 540d, 530d, 520d are separate components from each other and from the third plate section 540c, 530c, 520c. The first plate section 540a, 530a, 520a; second plate section 540b, 530b, 520b; third plate section 540c, 530c, 520c; and fourth plate section 540d, 530d, 520d may be joined or bonded to each other to form a single plate and/or bonded to plates or plate sections in other layers, for example using any of the bonding techniques described herein.

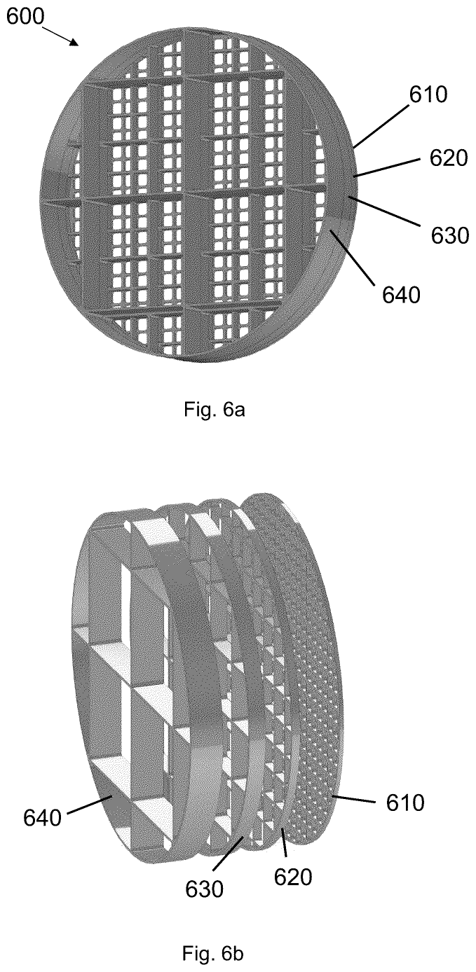

FIG. 6a depicts a core 600 according to embodiments of the present disclosure. FIG. 6b depicts an exploded view of core 600. The core 600 comprises a first plate 610, a second plate 620, a third plate 630 and a fourth plate 640. The first holes of the first plate 610 are smaller and greater in number than the second holes of the second plate 620. The second holes are smaller and greater in number than the third holes in the third plate 630. The third holes are smaller and greater in number than the fourth holes in the fourth plate 640. The features of the plates are the same as described with reference to FIGS. 4a and 4b, except that in this example, the holes through the entire thickness of each plate in the core are substantially square in cross-sectional shape.

As shown in FIGS. 6a and 6b, the square cross-sectional shapes of the holes provide a structure in which each of the third walls can entirely overlap two or more second walls and each of the second walls can entirely overlap two or more of the first walls, thereby maximising the bonding area between plates. However, such square-holed examples are not limited to this arrangement and it may be understood that the walls of each plate may be offset such that no such entire overlap occurs and instead the walls of one plate may cross brace the holes of an adjacent plate.

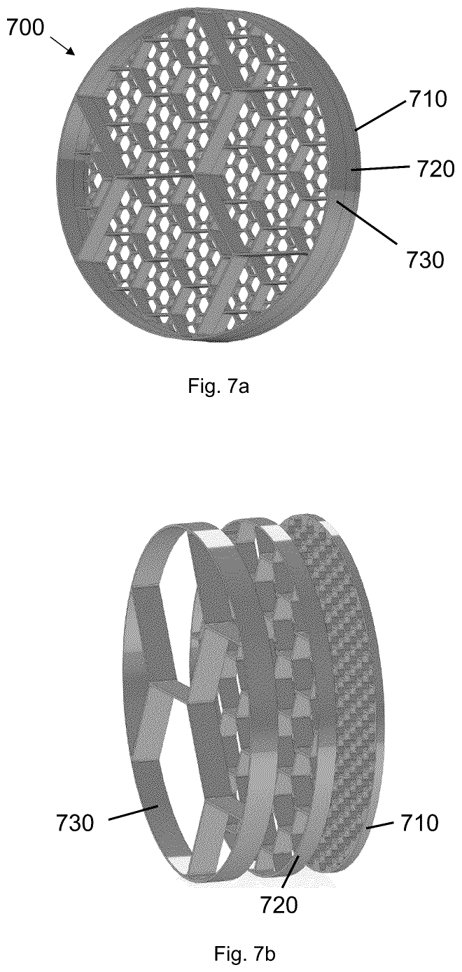

FIG. 7a depicts an core 700 according to embodiments of the present disclosure. FIG. 7b depicts an exploded view of core 700. The core 700 comprises a first plate 710, a second plate 720 and a third plate 730. The first holes of the first plate are smaller and greater in number than the second holes of the second plate. The second holes are smaller and greater in number than the third holes in the third plate. The features of the plates are the same as described with reference to FIGS. 4a and 4b, except that in this example, the holes through the entire thickness of each plate in the core are substantially hexagonal in shape. This creates a structure in which at least some portions of the third walls cross some of the second holes and at least some portions of the second walls cross at least some of the first holes. This can provide an improved balance between the cross-bracing effect and the increased bonding area effects described above.

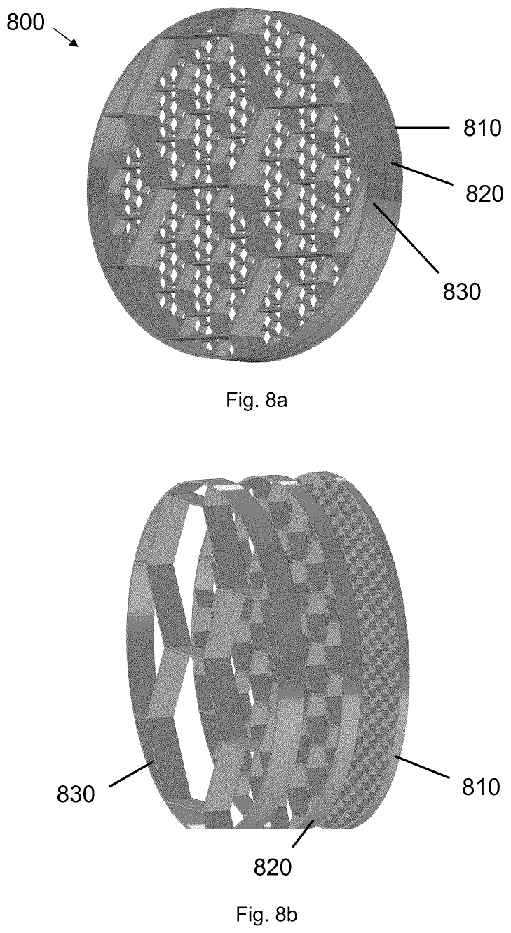

FIG. 8a depicts a core 800 according to embodiments of the present disclosure. FIG. 8b depicts an exploded view of core 800. The core 800 comprises a first plate 810, a second plate 820 and a third plate 830. The first holes of the first plate are smaller and greater in number than the second holes of the second plate. The second holes are smaller and greater in number than the third holes in the third plate. The features of the plates are the same as described with reference to FIGS. 4a and 4b, except that in this example, the holes through the entire thickness of each plate in the core are substantially hexagonal in shape. The difference between the example core 700 of FIGS. 7a and 7b and example core 800 is that the third plate 830 comprises smaller hexagonal holes than the third plate 730, and the structural members that make up the hexagons are also arranged differently. For example, all of the holes in the third plate 730 are substantially hexagonal as the edges of all of the holes are at least partially defined by the outer wall of the plate. By contrast, some of the holes in the third plate 830 are defined by six structural members that form straight lines, and other holes in the third plate have edges defined by the outer wall of the plate.

Although the outline shapes of the cores in FIGS. 4a, 4b, 6a, 6b, 7a, 7b, 8a and 8b are circular, the outline shape of each layer may not be circular. For example. The outline shapes may conform to the hole shapes so that the outline shape may be polygonal. For example. The outline shape of the plates may be octagonal.

Furthermore, the holes may adopt other shapes other than triangles, squares or hexagons. For example, octagon-shaped or even irregular-shaped holes may be used.

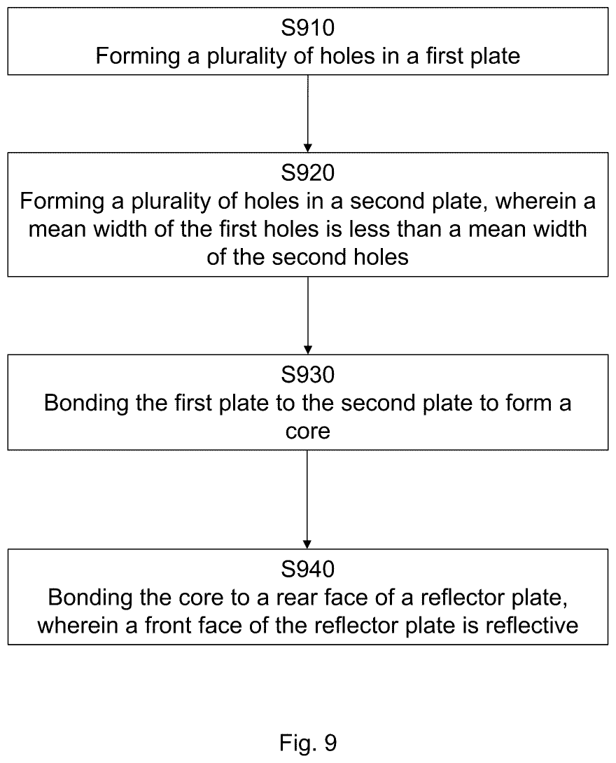

FIG. 9 depicts a method according to the present disclosure. The method is suitable for manufacturing any of the mirror devices described elsewhere in this disclosure.

At block S910, a plurality of holes are machined into a first plate.

At block S920, a plurality of holes are machined into the second plate. The first plate and second plate are each monolithic and comprise a glass or ceramic. A mean width of the first holes is less than a mean width of the second holes.

At block S930, the first plate is bonded to the second plate to form a core.

At block S940, the core is bonded to a rear face of a reflector plate. The front face of the reflector plate is reflective, as detailed elsewhere in this disclosure.

It may be understood that the first plate may be bonded to the reflector plate before being bonded to the second plate.

Optionally, the core may comprise more than two plates. These additional plates may also be bonded together. For example, a third plate with a plurality of third holes formed through the entire thickness of the third plate and having a mean width greater than the mean width of the second holes may be bonded to the second plate. The bonding technique may be the same as that used to bond the first plate and the second plate.

Optionally, the mirror device may further comprise a back plate as detailed elsewhere in this disclosure. The back plate may comprise features that facilitate bonding, for example features may be machined into the back plate that interlock or correspond with features of an adjacent plate of the core.

Bonding the plates of the core and/or the reflector plate and/or a back plate (if present) may comprise applying a low-expansion technique with a thin bond line. The thin bond line may be less than 50 micrometers. In some implementations, the core and the reflector plate and the back plate may comprise similar materials and in alternative implementations, they may be made from different materials such that dissimilar substrates are bonded to one another.

Low-expansion techniques with a bond line may eliminate the need for spacers between layers of the core, allowing the first plate and second plate of the core to be bonded directly to each other without any intermediate layers. This allows a larger core to be fabricated more easily, by bonding plates that may be fabricated separately, without comprising stability or optical performance. Spacers also add weight and reduce the optical performance of the core.

Bonding may comprise applying at least one of the following techniques: hydroxide catalysis bonding, cold metal bonding, diffusion bonding, glass frit, optical contacting and/or low CTE epoxy bonding. Bonding may alternatively be carried out using laser welding, for example ultra-short pulsed laser welding.

Hydroxide catalysis bonding is particularly suitable for optical systems, as it obtains high stability when bonding glass or ceramic materials. During the bonding process, hydroxide catalysis bonds are formed between adjacent plates by forming silicate-like networks or attaching covalently to a silicate-like network. As would be understood by the skilled person, the process may comprise three steps: hydration and etching, polymerization and dehydration. Typically, an alkaline bonding solution, such as sodium or potassium hydroxide or sodium silicate, is placed on one of the surfaces to be bonded and then the surfaces are brought into contact with one another.

Cold metal bonding is a welding process that takes place without fusion or heating at the interface of the surfaces being welding. There is no liquid or molten phase present in the joint.

Diffusion bonding is a joining or welding process that involves no liquid fusion. It is suitable for joining similar or dissimilar materials. An elevated temperature is applied to the materials to be joined, causing solid-state diffusion of the surfaces. In some implementations, high pressure may also be applied.

Advantageously, cold metal bonding and diffusion bonding methods introduce very little residual stress into the joint, and the materials of the bonded plates experience very little plastic deformation. There is also no weight added to the total weight of the core.

Glass frit bonding may also be referred to as glass soldering or seal glass bonding. It utilizes low melting-point glass which forms an intermediate glass layer. The viscous flow of the low melting-point glass allows it to compensate for surface irregularities and form hermetically sealed encapsulation of structures. Advantageously, the coefficient of thermal expansion of the glass used allows the join between plates to withstand temperature changes.

Optical contacting or optical contact bonding comprises two conformal surface being joined together by intermolecular forces. For example, two flat surfaces that are substantially free from contamination can be brought together without glue or fastenings. Since there is no binding agent or fastenings, the physical properties are the same as the surfaces being joined i.e., the properties of the plates comprising glass or ceramic. Advantageously, this method does not apply any deformation to the materials of the bonded plates, nor does it add any weight to the core.

Low CTE epoxy bonding comprises using an epoxy adhesive to bond two surfaces. Some epoxies will experience unequal expansion and contraction within the bond, which over time weakens the bond and can cause the structure to fail. Low CTE epoxies are particularly advantageous when bonding dissimilar substrates, as they are able to mitigate the difference in thermal expansion between the substrates being bonded. They therefore are able to retain thermal stability and are more reliable. Low CTE adhesives may comprise adhesives which have had a low expansion filler added such as, for example, silica powder, alumina, metallic particles, quartz, ceramic powders, and/or nanoparticles.

In laser welding, a laser is focused at or near the interface (i.e. mated faces or parts) between layers, plates or plate sections. The heat buildup from successive laser pulses (or the heat from a pass of a continuous-wave laser) causes localized melting of the material. The subsequent solidification results in strong and durable bonds. Laser welding of the plates, plate sections or layers offers a non-contact, high-precision, and high-speed process that eliminates the need for intermediate layers. Examples include ultra-short pulsed laser welding, CO2 laser welding, and laser micro welding. Ultra-short pulsed laser welding is particularly well suited to glass or ceramic materials. The ultrashort pulse durations, spanning femtoseconds to picoseconds, enable nonlinear absorption processes within the material, allowing for localized energy deposition while minimizing heat transfer to surrounding areas. This precision reduces heat-affected zones and thermal distortion. Additionally, ultrafast lasers generate high peak powers that create a “cold welding” effect, enabling material bonding with minimal melting—an especially beneficial characteristic for heat-sensitive materials like glass.

In some implementations, the mirror device may further comprise a bonding layer disposed between adjacent, bonded plates. For example, between the first plate 220 and second plate 230 and/or between the first plate 220 and the reflector plate 210. The bonding layer may comprise an epoxy, glass frit, sodium silicate or metal. In some embodiments, the bonding layer is formed of the same material or materials as the bonded surfaces.

It will be understood that the above description of specific embodiments is by way of example only and is not intended to limit the scope of the present disclosure. Many modifications of the described embodiments, some of which are now described, are envisaged and intended to be within the scope of the present disclosure.

In some implementations, the mirror device will not be cylindrical, and the cross-sectional shape will not be circular. In some implementations, the holes may be arranged in an irregular pattern or have irregular shapes.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

Also disclosed herein are the following numbered embodiments:

Embodiment 1. A mirror device comprising:
a reflector plate having a rear face and a reflective front face,
a core attached to the rear surface of the reflector plate;
wherein the core comprises a first plate and a second plate, the first plate stacked on the second plate, wherein the first plate and second plate are each monolithic and comprise a glass or ceramic;
a plurality of first holes is formed in the first plate, each first hole formed through the entire thickness of the first plate; and
a plurality of second holes is formed in the second plate, each second hole formed through the entire thickness of the second plate;
wherein a mean width of the first holes is less than a mean width of the second holes.

Embodiment 2. The mirror device of embodiment 1, wherein the core further comprises a third plate that is monolithic and comprises a glass or ceramic, and wherein a plurality of third holes are formed in the third plate, each third hole formed through the entire thickness of the third plate and having a mean width greater than the mean width of the second holes.

Embodiment 3. The mirror device of embodiment 1 or 2, wherein the first plate is disposed between the reflector plate and the second plate.

Embodiment 4. The mirror device of any preceding embodiment, wherein the first plate is immediately adjacent to the second plate and/or the first plate is immediately adjacent to the reflector plate.

Embodiment 5. The mirror device of embodiment 4, wherein the first plate is bonded to the second plate and/or the first plate is bonded to the reflector plate.

Embodiment 6. The mirror device of any preceding embodiment, wherein a thickness of the first plate is not equal to thickness of the second plate, and optionally wherein the thickness of the first plate is less than the thickness of the second plate.

Embodiment 7. The mirror device of any preceding embodiment, wherein the number of second holes is less than the number of first holes.

Embodiment 8. The mirror device of embodiment 7, wherein the number of first holes is an integer multiple of the number of second holes, and optionally wherein the integer is between 2 and 9, optionally between 3 and 5 and optionally four.

Embodiment 9. The mirror device of any preceding embodiment, wherein the glass or ceramic is a low expansion glass-ceramic, and optionally wherein a thermal expansion of the low expansion glass-ceramic is less than one part per million per degree Celsius, optionally less than 0.1 parts per million per degree Celsius.

Embodiment 10. The mirror device of any preceding embodiment, further comprising a back plate attached to the core such that the core is disposed between the reflector plate and the back plate.

Embodiment 11. The mirror device of embodiment 10, wherein the back plate comprises at least one opening configured to allow air flow to the core.

Embodiment 12. The mirror device of embodiment 10 or 11, wherein the back plate comprises a cross-bracing portion spanning at least one hole in an adjacent plate.

Embodiment 13. The mirror device of embodiment 10, wherein the back plate is monolithic.

Embodiment 14. The mirror device of embodiment 10, wherein the back plate is optically functional.

Embodiment 15. The mirror device of any preceding embodiment, wherein the first plate comprises a first outer frame and a plurality of first structural members defining edges of the first holes, and
wherein the second plate comprises a second outer frame and a plurality of second structural members defining edges of the second holes.

Embodiment 16. The mirror device of embodiment 15, wherein the first holes and the second holes are formed of a base shape, optionally wherein the base shape is tessellating or wherein the base shape is one of: substantially triangular, substantially circular, substantially square, or substantially hexagonal.

Embodiment 17. The mirror device of embodiment 15 or 16, wherein a base shape of the first holes is the same as a base shape of the second holes.

Embodiment 18. The mirror device of any preceding embodiment, wherein at least one first wall between the first holes overlaps with at least one second wall between the second holes, optionally wherein at least one first wall overlaps entirely with at least one second wall, and/or wherein at least one second wall crosses a first hole.

Embodiment 19. The mirror device of embodiment 18, wherein the first outer frame overlaps with the second outer frame.

Embodiment 20. The mirror device of embodiment 18 or 19, wherein the first plate is bonded to the second plate in the overlapped region.

Embodiment 21. The mirror device of any preceding embodiment, wherein the core comprises:
a fourth plate, wherein the fourth plate is monolithic and comprises a glass or ceramic; and
a plurality of fourth holes is formed in the fourth plate, each fourth hole formed through the entire thickness of the fourth plate;
wherein the fourth plate is positioned in a same layer of the core as the first plate.

Embodiment 22. The mirror device of embodiment 21, wherein the fourth plate and first plate are of equal thickness.

Embodiment 23. The mirror device of embodiment 21 or 22, wherein the mean width of the fourth holes is equal to the mean width of the first holes, and optionally wherein the fourth plate is identical to the first plate.

Embodiment 24. The mirror device of any preceding embodiment, wherein the first plate is adjacent to the reflector plate, and the ratio of the a thickness of the reflector plate to a mean, minimum or maximum width of the first holes is between 1:3 and 1:7, optionally 1:5.

Embodiment 25. The mirror device of any preceding embodiment, wherein the first plate is disposed between and immediately adjacent to the reflector plate and the second plate, and
wherein a ratio of a combined thickness of the reflector plate and first plate to a mean, minimum or maximum width of the second holes is 1:3 to 1:7, optionally 1:5.

Embodiment 26. The mirror device of any preceding embodiment, wherein a ratio of a thickness of the mirror device to a maximum lateral size of the mirror device is between 1:3 to 1:7, optionally 1:5.

Embodiment 27. The mirror device of any preceding embodiment, wherein a bonding layer is disposed between the first plate and second plate and/or between the first plate and the reflector plate, optionally wherein the bonding layer comprises an epoxy, glass frit, sodium silicate or metal.

Embodiment 28. The mirror device of any preceding embodiment, wherein at least one of the first plate, second plate, reflector plate and back plate comprises a mounting feature, optionally wherein the mounting feature comprises a protrusion arranged to locate in a recess in an adjacent layer or a recess arranged to receive a protrusion in an adjacent layer.

Embodiment 29. A method of manufacturing a mirror device, wherein the method comprises:
machining a plurality of first holes into a first plate;
machining a plurality of second holes into a second plate, wherein the first plate and second plate are each monolithic and comprise a glass or ceramic, and a mean width of the first holes is less than a mean width of the second holes;
bonding one face of the first plate to the second plate; and
bonding an opposite face of the first plate to a rear face of a reflector plate, wherein a front face of the reflector plate is reflective.

Embodiment 30. The method of embodiment 29, wherein bonding the plurality of plates comprises applying a low-expansion technique with a thin bond line to adjacent plates, and optionally wherein the thin bond line is less than 50 micrometres.

Embodiment 31. The method of embodiment 29 or 30, wherein bonding the first and second plates comprises applying at least one of the following techniques: hydroxide catalysis bonding, cold metal bonding, diffusion bonding, glass frit, optical contacting, laser welding, and/or low CTE epoxy bonding.

Embodiment 32. A mirror device obtainable by the method according to any of embodiments 29 to 31.

1. A mirror device comprising:
a reflector plate having a rear face and a reflective front face;
a core attached to a rear surface of the reflector plate,
wherein the core comprises a first plate and a second plate, the first plate stacked on the second plate, wherein the first plate and second plate are each monolithic and comprise a glass or ceramic;
a plurality of first holes is formed in the first plate, each first hole formed through the entire thickness of the first plate; and
a plurality of second holes is formed in the second plate, each second hole formed through the entire thickness of the second plate,
wherein a mean width of the first holes is less than a mean width of the second holes.

2. The mirror device of claim 1, wherein the core further comprises a third plate that is monolithic and comprises a glass or ceramic, and wherein a plurality of third holes are formed in the third plate, each third hole formed through the entire thickness of the third plate and having a mean width greater than the mean width of the second holes.

3. The mirror device of claim 1, wherein the first plate is disposed between the reflector plate and the second plate.

4. The mirror device of claim 1, wherein the first plate is immediately adjacent to the second plate and/or the first plate is immediately adjacent to the reflector plate.

5. The mirror device of claim 4, wherein the first plate is bonded to the second plate and/or the first plate is bonded to the reflector plate.

6. The mirror device of claim 1, wherein a thickness of the first plate is not equal to thickness of the second plate, and optionally wherein the thickness of the first plate is less than the thickness of the second plate.

7. The mirror device of claim 1, wherein:
a number of second holes is less than a number of first holes;
a ratio of a thickness of the mirror device to a maximum lateral size of the mirror device is between 1:3 to 1:7;
a bonding layer is disposed between the first plate and second plate and/or between the first plate and the reflector plate, optionally wherein the bonding layer comprises an epoxy, glass frit, sodium silicate or metal; and/or
at least one of the first plate, second plate, reflector plate and back plate comprises a mounting feature, optionally wherein the mounting feature comprises a protrusion arranged to locate in a recess in an adjacent layer or a recess arranged to receive a protrusion in an adjacent layer.

8. The mirror device of claim 7, wherein the number of first holes is an integer multiple of the number of second holes, and optionally wherein the integer is between 2 and 9.

9. The mirror device of claim 1, wherein the glass or ceramic is a low expansion glass-ceramic, and optionally wherein a thermal expansion of the low expansion glass-ceramic is less than one part per million per degree Celsius.

10. The mirror device of claim 1, further comprising a back plate attached to the core such that the core is disposed between the reflector plate and the back plate, wherein:
the back plate comprises at least one opening configured to allow air flow to the core;
the back plate comprises a cross-bracing portion spanning at least one hole in an adjacent plate;
the back plate is monolithic; and/or
the back plate is optically functional.

11. The mirror device of claim 1, wherein the first plate comprises a first outer frame and a plurality of first structural members defining edges of the first holes; and
wherein the second plate comprises a second outer frame and a plurality of second structural members defining edges of the second holes.

12. The mirror device of claim 11, wherein the first holes and the second holes are formed of a base shape; and
wherein the base shape is tessellating or wherein the base shape is one of: substantially triangular, substantially circular, substantially square, or substantially hexagonal.

13. The mirror device of claim 11, wherein:
at least one first wall between the first holes overlaps with at least one second wall between the second holes, optionally wherein at least one first wall overlaps entirely with at least one second wall, and/or wherein at least one second wall crosses a first hole;
a base shape of the first holes is the same as a base shape of the second holes;
the first outer frame overlaps with the second outer frame; and/or
the first plate is bonded to the second plate in the overlapped region.

14. The mirror device of claim 1, wherein the core comprises:
a fourth plate, wherein the fourth plate is monolithic and comprises a glass or ceramic; and
a plurality of fourth holes is formed in the fourth plate, each fourth hole formed through the entire thickness of the fourth plate,
wherein the fourth plate is positioned in a same layer of the core as the first plate.

15. The mirror device of claim 14, wherein the fourth plate and first plate are of equal thickness.

16. The mirror device of claim 14, wherein:
the mean width of the fourth holes is equal to the mean width of the first holes, and optionally wherein the fourth plate is identical to the first plate;
the first plate is adjacent to the reflector plate, and the ratio of a thickness of the reflector plate to a mean, minimum or maximum width of the first holes is between 1:3 and 1:7; and/or
the first plate is disposed between and immediately adjacent to the reflector plate and the second plate, and wherein a ratio of a combined thickness of the reflector plate and first plate to a mean, minimum or maximum width of the second holes is 1:3 to 1:7.

17. A method of manufacturing a mirror device, wherein the method comprises:
machining a plurality of first holes into a first plate;
machining a plurality of second holes into a second plate, wherein the first plate and second plate are each monolithic and comprise a glass or ceramic, and a mean width of the first holes is less than a mean width of the second holes;
bonding one face of the first plate to the second plate; and
bonding an opposite face of the first plate to a rear face of a reflector plate, wherein a front face of the reflector plate is reflective.

18. The method of claim 17, wherein bonding the plurality of plates comprises applying a low-expansion technique with a thin bond line to adjacent plates, and optionally wherein the thin bond line is less than 50 micrometres.

19. The method of claim 17, wherein bonding the first and second plates comprises applying at least one of the following techniques: hydroxide catalysis bonding, cold metal bonding, diffusion bonding, glass frit, optical contacting, laser welding, and/or low CTE epoxy bonding.

20. A mirror device obtainable by the method according to claim 17.
